(19) United States
(12) Patent Application Publication
(10) Pub. No.: US 2007/0057219 A1
(43) Pub. Date: Mar. 15, 2007

(54) Easy stop for outlet poppet

(75) Inventor: Hua-Ching Lin, Huatan Township (TW)

Correspondence Address: TROXELL LAW OFFICE PLLC, SUITE 1404, 5205 LEESBURG PIKE, FALLS CHURCH, VA, 22041, US

(73) Assignee: Zchance Industries Co., Ltd.

(21) Appl. No.: 11/222,870

(22) Filed: Sep. 12, 2005

(51) Int. Cl. F16K 51/00

(52) U.S. Cl. 251/155

(57) ABSTRACT

An easy stop for outlet poppet, which is composed of outlet end screwed with thread joint of outlet poppet, inlet end screwed with outlet pipe of water storage tank of valve and valve rod put into from inlet end of valve, its features are as follows: positioning flange edge is made in inner middle section of valve, conic-shaped perforation is set in center of positioning flange and front part of valve rod is made as stair-shaped rod so as to provide a push block as clip positioning, the outer ring of its end part is conic-shaped, which is positioned with conic-shaped perforation of positioning flange in middle section of valve, one concave force groove is made at center of its end edge in rod direction; however, when one outlet poppet is screwed with outlet end of valve, this outlet poppet is to press push block and drive valve rod to move toward inlet end of valve so as to form an access inside valve, water is then pushed into outlet poppet from inlet end of valve; if want to dismantle outlet poppet from valve because of repair or replacement, force groove at end of valve rod, under function of hydraulic pressure, may drive conic-shaped outer ring to position with conic-shaped perforation at inner of valve and block water accordingly. Therefore, you can get an easy stop with simple structure, which can prevent water from leaking, safe and convenient to replace outlet poppet.

### BACKGROUND OF THE INVENTION

1) Field of the Invention

This invention relates to an easy stop for outlet poppet, which herein means a type of outlet poppet with simple structure, can prevent water from leaking and easy to replace.

2) Description of the Prior Art

As to the outlet pipe of the current common water storage tank (such as water tower), if want to make further connection to outlet poppet(such as faucet) so that water in water storage tank can flow out from outlet poppet, usually, thread joint of outlet poppet is directly screwed with outlet end of water storage tank's outlet pipe.

However, as time goes on, especially construction of high buildings, their water storage tanks are usually installed on roof of building. In case the outlet poppet screwed with outlet pipe leaked after a period time of use and must be replaced accordingly, installation persons must climb up to roof and close the general valve before the replacement, otherwise if take out outlet poppet directly from outlet pipe of water storage tank, may cause serious water resource waste. When replace, the installation persons must climb up to roof and close the master valve, therefore, it is very inconvenient. Thereby, the development to provide easy stop for outlet poppet has been done based on the above shortcomings, please refer to FIG. 1 and FIG. 2, take outlet poppet 2 (round faucet) as example, its easy stop is mainly composed of valve 3, valve rod 4, thrust spring 5 and push block 6, wherein:

Valve 3 is a tube 31 whose inlet end 32 is screwed onto outlet pipe 7 of water storage tank (such as water tower) with outer thread 321, and outlet end 33 is set inner thread 331 so that outlet poppet 2 can be screwed onto outlet end 33 of valve 3 with thread joint 21, stopper 322 in concave arc shape is fixed in outer side of inlet end 32 of valve 3, a stair-shaped support edge 34 is set on inner wall of valve 3 near outlet end 32.

Valve rod 4 is rod 41 with protruding edge 411 at one end, which is to penetrate through inner side of valve 3 so as to let protruding edge 411 expose outside of inlet end 32 of valve 3, conic-shaped plug 42 made of rubber is set on protruding rim 411 in accordance with stopper 322 of valve 3 which is covered at bottom of rod 41 of valve rod 4.

Thrust spring 5 is to install in inner side of valve 3 and cover onto valve rod 4, in addition, one end of this thrust spring 5 resists against inner wall of support edge 34 of valve 3.

Push block 6 is to screw onto rod 41 of valve rod 4, one side of it presses on another end of push block 6 far away from support edge 34, and one locked nut 61 is locked on outer side of push block 6 on rod 41 of valve rod 4.

When assembled based on above described structure, inlet end 32 of valve 3 of the easy stop can be screwed onto outlet pipe 7 of water storage tank with outer thread 321 so as to lock the easy stop with outlet pipe 7, so, thread joint 21 of outlet poppet 2 is screwed with outlet end 33 of valve 3 when want to install faucet 2, outer end of thread joint 21 of outlet poppet presses push block 6 so as to drive valve rod 4 to move toward inlet end 32 of valve 3 and open plug 42, so that outlet poppet 2 can let water in water storage tank flow out outlet pipe 7 through valve 3 and supply it to outlet poppet 2 from outlet end 33; furthermore, as the stop ring is required to dismantle because of leaking or trouble due to material fatigue after period time of use, thread joint 21 is to exit from inner thread 331 of outlet end 33 of valve 3, push block 6 of the easy stop is pushed by thrust spring 5 so as to drive valve rod 4 to move toward outlet end 33, meanwhile, pull plug 42 toward outlet end 32 of valve 3, and let plug 42 press on stopper 322 of valve 3 so as to block water, therefore, water in the water storage tank may be blocked by plug 42, which may not flow out from valve 3. Especially in dismantling outlet poppet 2, valve rod 4 of valve 3 may be automatically closed at once if only outlet poppet was dismantled, you don't worry about water-leaking from water storage tank, therefore, there isn't any trouble in the replacement and waste of water.

The above described structure of easy stop can prevent water from leaking so as to save water resource and also easy to replace when plan to replace outlet poppet, such as faucet, however, at first, the whole structure of this easy stop must be composed of valve 3, valve rod 4, thrust spring 5, push block 6, locked nut 61 screwed on outer side of push block 6 that locks valve rod 4, thrust spring 5 and push block 5, its components are very complicated, thereby, it is required to make improvement due to its difficulty to assemble and increase of material cost.

Secondly, plug 42 covering one end of rod 41 of valve rod 4 is made of rubber material, which is easy to have qualitative change and cause material fatigue, especially, when water flow into valve 3 is hot, it may be easier to get into such trouble, therefore, its seal with support edge 34 of valve 3 may be seriously affected when it resists against the support edge so as to cause leaking;

Third, the reason why plug 42 covering one end of rod 41 of valve rod 4 can press stopper 322 of valve 3 and block up water is because push block 6 of easy stop is pushed by thrust spring 5 and drive valve rod 4 to move toward outlet end 33, plug 42 is therefore pulled toward outlet end 32 of valve 3. Meanwhile, thrust spring 5 may have elasticity fatigue after a period time of use so that plug 42 may not effectively press stopper 322 of valve 3, that may cause leaking, furthermore, such leaking may hurt people in case of hot water, therefore, it is necessary to make improvement.

### SUMMARY OF THE INVENTION

This invention is to make further improvement on basis of above ill structure described, its purpose is to provide an easy stop for outlet poppet, which is composed of one outlet end that can be screwed with thread joint of outlet poppet and inlet end that can be screwed with valve of outlet pipe of water storage tank and one valve rod put into from inlet end of valve. Its features are as follows: one positioning flange is set in ring in inner wall of valve's middle section, and conic-shaped perforation is made in center of positioning flange, the front part of valve rod is set as stair-shaped rod so that push block can be used for block positioning, outer ring of its end section is made as conic shape which may position with the conic-shaped perforation of positioning flange in middle section of valve, and one force groove is made at the center of its end edge in rod direction. When one outlet poppet is screwed with outlet end of valve, it may press push block and then drive valve rod to move toward inlet end so as to form an access in valve, and water can flow toward outlet poppet from inlet end of valve; if want to replace and dismantle outlet poppet from valve, the force groove at end edge of valve can make the conic-shaped outer ring at end section of rod resist against conic-shaped perforation inside valve and block up water accordingly, so that this easy stop has simple structure, can prevent water from leaking, safe and easy to replace outlet poppet.

The second purpose of this invention is to provide an easy stop for outlet poppet, wherein the whole easy stop is only composed of one valve rod, one valve rod and one push block, therefore, its cost of production and material may be reduced sharply, and also easy to assemble due to its simple structure.

The third purpose of this invention is to provide an easy stop for outlet poppet, wherein valve rod of the easy stop is made as conic shape in ring from outer edge of its end so as to position it with the conic-shaped perforation on positioning flange in middle section of valve, and one force groove is made at center of the end in rod direction because it is made of same material (such as metal material); therefore, even if water flowing into valve is hot, it will not cause material fatigue as the common plug made of rubber material, so that the conic-shaped outer ring at end part of valve rod can be effectively positioned with conic-shaped perforation in inner wall of valve and block water accordingly.

The fourth purpose of this invention is to provide an easy stop for outlet poppet, wherein valve rod of easy stop, because the conic-shaped outer ring at its end part can be effectively positioned with conic-shaped perforation in inner wall of valve and block up water accordingly, therefore, as outlet poppet is broken, it can be directly dismantled and replaced, furthermore, when water flowing into easy stop is hot, which may not spray out from outlet end of easy stop and hurt anybody around, so it is very safe.

### BRIEF DESCRIPTION OF THE DRAWINGS

FIG. 1 is the three-dimensional exploded view of common structure.

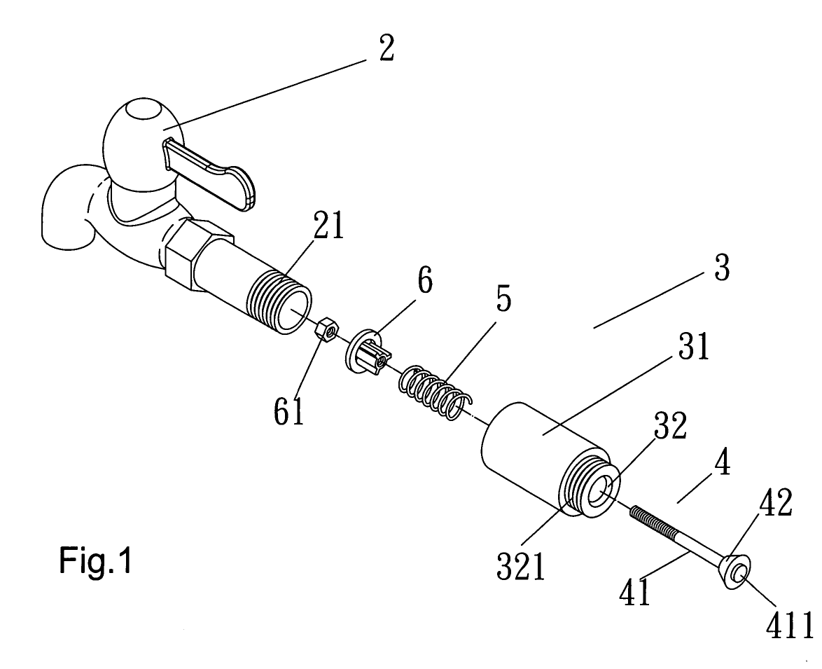

FIG. 2 is the combined section sketch map of common structure.

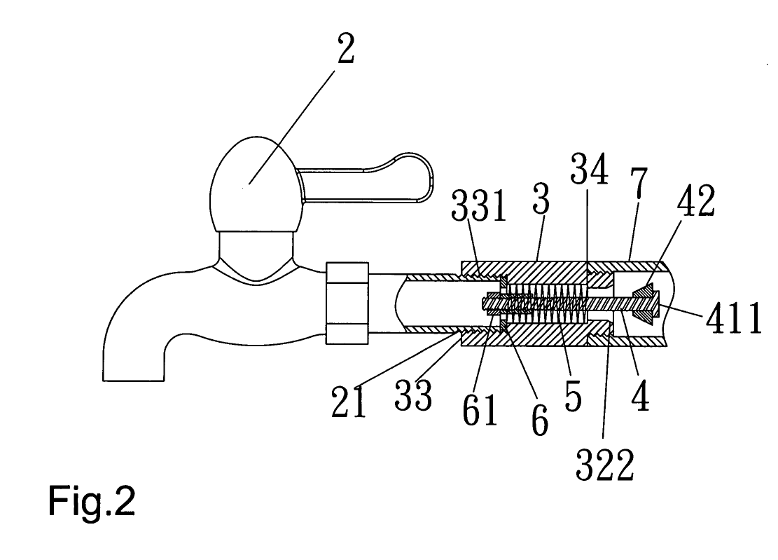

FIG. 3 is the three-dimensional exploded view of structure of this invention.

FIG. 4-A is the combined section operational sketch map of structure of this invention.

FIG. 4-B is the combined section operational sketch map of structure of this invention.

FIG. 5 is another executive sketch map of structure of this invention.

### DETAILED DESCRIPTION OF THE PREFERRED EMBODIMENTS

The features and operations of this invention are described with figures in the following, which are used for you reference.

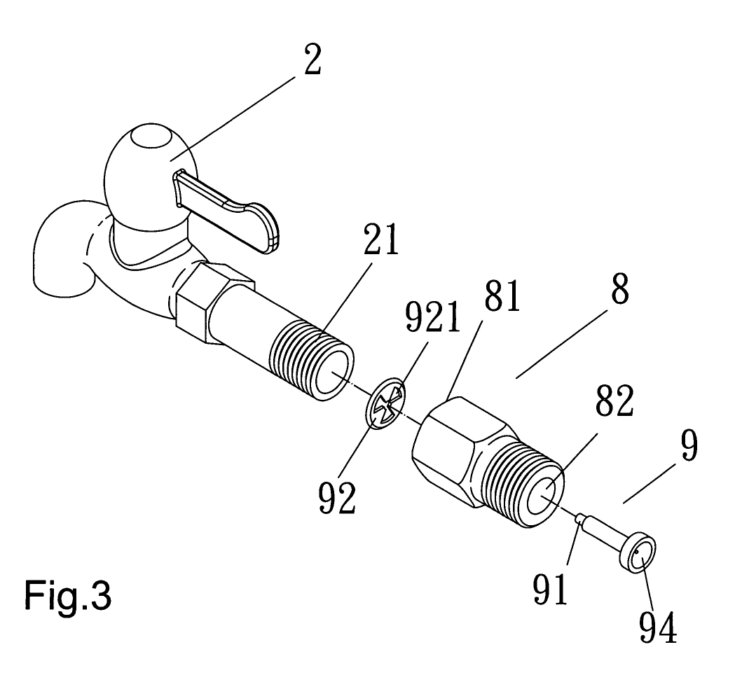

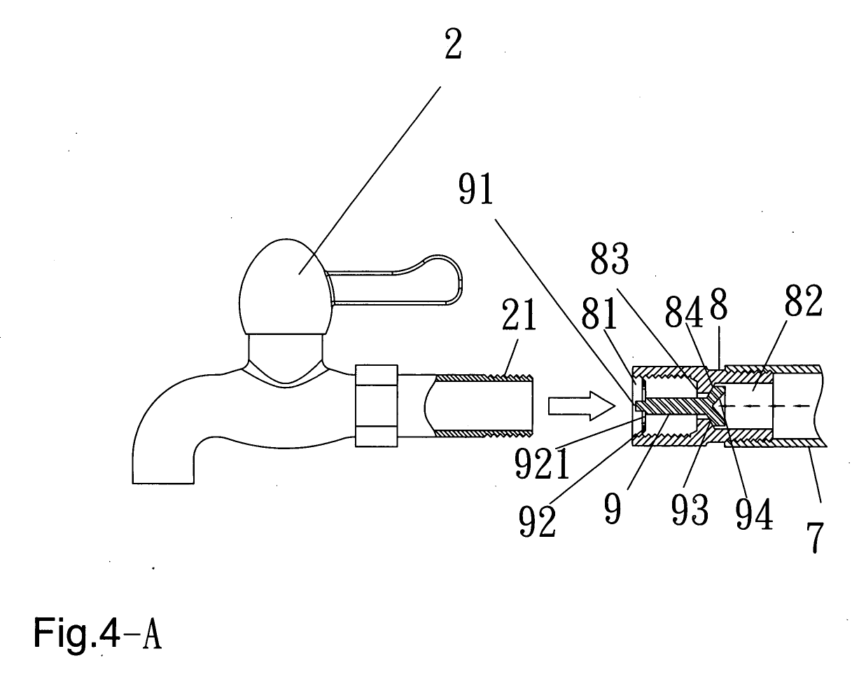

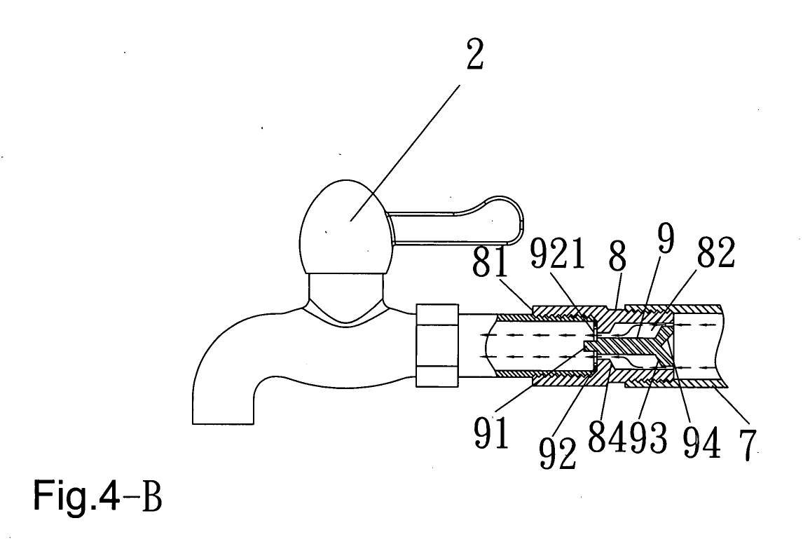

First, please refer to FIG. 3, FIG. 4-A and FIG. 4-B, easy stop of outlet poppet of this invention, which is composed of outlet end 81 screwed with thread joint 21 of outlet poppet 2 (this figure uses faucet as example), inlet end 82 screwed with valve 8 of outlet pipe 7 of water storage tank and rod 9 put into from inlet end 82 of valve 8. However, the key feature of this invention is as follows: positioning flange edge 83 is made in inner middle section of valve 8, conic-shaped perforation 84 is set in center of positioning flange 83 and front part of valve rod 9 is made as stair-shaped rod 91, on which several perforations 921 are fixed and have clip position with push block 92, its end section's outer ring 93 is conic-shaped, which is positioned with conic-shaped perforation 84 on positioning flange 83 in middle section of valve 8, one sharp conic-shaped force groove is made in center of end part in rod direction.

After assembled based on above described structure, outlet end 82 of valve 8 of this easy stop is first screwed with outlet pipe of water storage tank so that the easy stop is thereby locked with outlet 7, therefore, if plan to install outlet poppet 2 with outlet end 81 of valve 8, just let outlet poppet 2 press push block 92 and drive valve rod 9 to move toward outlet end 82 of valve 8, then, an access may be formed inside valve 8, water is pushed toward outlet poppet 2 from inlet end 82 of valve 8; if want to dismantle outlet poppet 2 from valve 8 because of replacement, sharp conic-shaped force groove 94 at end of valve rod 9, under function of hydraulic pressure, may drive conic-shaped outer ring 93 to position with conic-shaped perforation 84 in inner wall of valve 8 and block water accordingly. Therefore, you can get an easy stop with simple structure, which can prevent water from leaking, safe and convenient to replace outlet poppet.

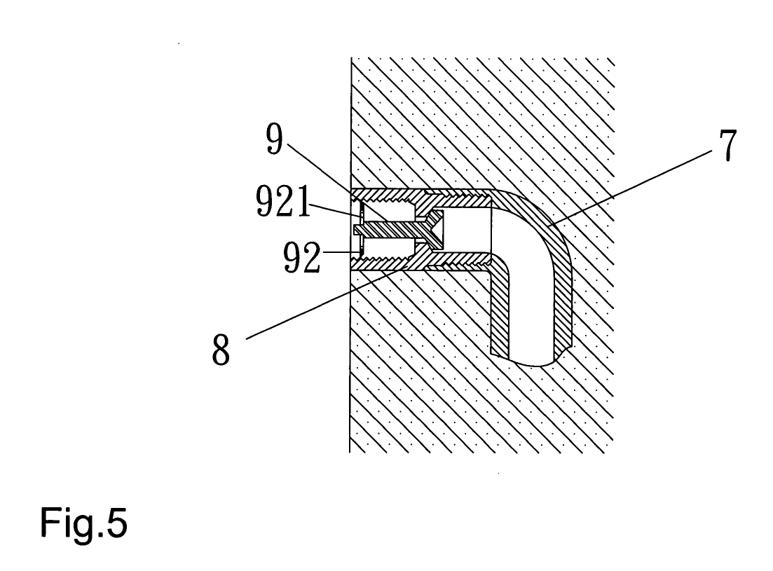

In addition, please refer to FIG. 5, the easy stop can also be molded with the end of outlet pipe 7 when primarily make outlet pipe 7 of water storage tank, so that outlet pipe 7 may have similar structure of easy stop as well.

What is claimed is:

1. An easy stop for outlet poppet, which is composed of outlet end screwed with thread joint of outlet poppet, inlet end screwed with outlet pipe of water storage tank of valve and valve rod put into from inlet end of valve, its features are as follows: positioning flange edge is made in inner middle section of valve, conic-shaped perforation is set in center of positioning flange and front part of valve rod is made as stair-shaped rod so as to provide a push block as clip positioning, outer ring of its end part is conic-shaped, which is positioned with conic-shaped perforation of positioning flange in middle section of valve, one concave force groove is made at center of its end edge in rod direction;
After assembled based on above described structure, you can get an easy stop with simple structure, which can prevent water from leaking, safe and convenient to replace outlet poppet.

2. Described as claim 1, which is an easy stop of outlet poppet, it can be molded with the end of outlet pipe when primarily make outlet pipe of water storage tank, so that outlet pipe may have similar structure of easy stop as well.

3. Described as claim 3, which is an easy stop of outlet poppet, wherein force groove set at end of valve rod prefers to a sharp conic shape.
